(19) United States
(12) Patent Application Publication
(10) Pub. No.: US 2008/0245331 A1
(43) Pub. Date: Oct. 9, 2008

(54) ENGINE

(75) Inventors: Toshimichi Kumagai, Kyoto-fu (JP); Masanobu Yamamoto, Shizuoka-ken (JP); Shinichi Kajiya, Shizuoka-ken (JP)

Correspondence Address: KNOBBE MARTENS OLSON & BEAR LLP, 2040 MAIN STREET, FOURTEENTH FLOOR, IRVINE, CA, 92614, US

(73) Assignees: Kyoto Denkiki Co., LTD, Kyoto-fu (JP); Yamaha Motor Power Products Kabushiki Kaisha, Shizuoka-ken (JP)

(21) Appl. No.: 11/775,830

(22) Filed: Jul. 10, 2007

(30) Foreign Application Priority Data
Apr. 4, 2007 (JP) 2007-098539

(51) Int. Cl. F02D 41/06

(52) U.S. Cl. 123/179.16

(57) ABSTRACT

An engine includes a choke valve for varying the opening of an intake passage. When a variation in an engine operating state per unit time during the operation of the engine becomes a predetermined value or greater, the choke valve is automatically moved to the fully open position to thereby bring the engine back to the normal operating state immediately.

### CROSS-REFERENCE TO RELATED APPLICATIONS

The present application is based on and claims priority under 35 U.S.C. § 119 to Japanese Patent Application No. 2007-098539, filed on Apr. 4, 2007, the entire contents of which are expressly incorporated by reference herein.

### BACKGROUND OF THE INVENTION

1. Field of the Invention

The present invention relates to an engine including a choke valve for varying the opening of an intake passage.

2. Description of the Related Art

A conventional engine is disclosed in Japanese Publication No. JP 60-222547. This engine includes a choke valve for varying the opening of an intake passage. During the start of the engine, the choke valve is controlled to move from the fully closed position to a proper valve opening amount based on the temperature of the engine, and the like. The air-fuel ratio (A/F) of a mixture to be supplied to the engine is thereby decreased, so that the richer mixture will be supplied to the engine for the proper start of the engine.

After the start of the engine, the choke valve is fully opened. The air-fuel ratio is thereby increased, so that the mixture to the engine will become moderately lean, and the engine will thus be brought to a normal operating state.

During the normal operation of the engine, if the engine is subject to large vibrations due to a significant change in engine load in a short period of time, or if the choke valve is accidentally operated by a user, the choke valve may suddenly close by a large amount. In such case, the air-fuel ratio of the mixture to be supplied to the engine will be decreased sharply (e.g., the mixture will become richer), resulting in the disadvantage of a sharp decrease in the output of the engine.

### SUMMARY OF THE INVENTION

In view of the circumstances noted above, an aspect of at least one of the embodiments disclosed herein is to provide an engine in which if a choke valve is closed suddenly for some reason during the normal operation of the engine, resulting in a sharp decrease in the output of the engine, the choke valve is controlled to fully open automatically to thereby immediately bring the engine back to the normal operating state.

In accordance with one aspect of the present invention, an engine including a choke valve configured to vary the opening of an intake passage of the engine is provided. The choke valve is controlled to move to a fully open position when a variation in an engine operating state per unit time during the operation of the engine becomes equal to or greater than a predetermined value.

In accordance with another aspect of the present invention, a method for operating an engine is provided. The method comprises determining if a variation in an engine operating state per unit time has become equal to or greater than a predetermined value and controlling a choke valve of the engine to move to a fully open position if the variation in engine operating state is equal to or greater than the predetermined value.

### BRIEF DESCRIPTION OF THE DRAWINGS

These and other features, aspects and advantages of the present inventions will now be described in connection with preferred embodiments, in reference to the accompanying drawings. The illustrated embodiments, however, are merely examples and are not intended to limit the inventions. The drawings include the following 2 figures.

FIG. 1 is a schematic diagram generally illustrating a generating apparatus.

FIG. 2 is a flowchart of a control process for a controller of the generating apparatus shown in FIG. 1.

### DETAILED DESCRIPTION OF THE PREFERRED EMBODIMENT

A preferred embodiment is described below to provide an engine in which if a choke valve is closed suddenly for some reason during the normal operation of the engine, resulting in a sharp decrease in the output of the engine, the choke valve is controlled to fully open automatically to thereby bring the engine back to the normal operating state immediately.

More specifically, in one embodiment, the engine includes a choke valve for varying the opening of an intake passage. When a variation in an engine operating state per unit time during the operation of the engine becomes greater than or equal to a predetermined value, the choke valve is moved to the fully open side.

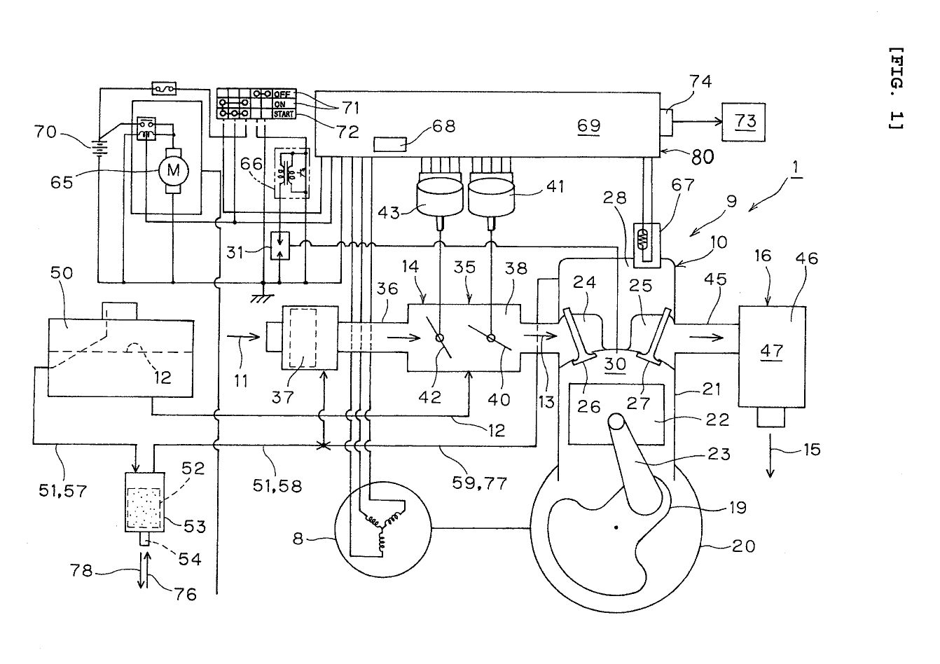

FIG. 1 illustrates a portable generating apparatus 1.

The generating apparatus 1 can have a trolley that can be placed on a work surface, such as the ground or the floor, and be movable on the work surface. On the trolley, a four-stroke engine 9 can be supported for driving a three-phase AC generator 8. The engine 9 can include an engine body 10, an intake member 14 and an exhaust member 16. The engine body 10 outputs driving force. The intake member 14 supplies a mixture 13 of air 11 and fuel 12 to the engine body 10. The exhaust member 16 discharges burnt gas of the mixture 13 burnt in the engine body 10 to the outside as exhaust 15.

The engine body 10 can include a crankcase 20, a cylinder 21, a piston 22, a connecting rod 23, intake and exhaust valves 26, 27 and a valve mechanism (not shown). The crankcase 20 supports a crankshaft 19 therein. The cylinder 21 protrudes from the crankcase 20. The piston 22 is fitted in the cylinder 21 in a manner slidable axially therealong. The connecting rod 23 operatively connects the crankshaft 19 and the piston 22. The intake and exhaust valves 26, 27 can selectively open and close intake and exhaust passages 24, 25, respectively, formed at a protruded end of the cylinder 21. The valve mechanism can selectively open and close the intake and exhaust valves 26, 27 enclosed in a valve chamber 28 which is formed at the protruded end of the cylinder 21. A spark plug 31 is provided with an electrical discharge part facing a combustion chamber 30 in the cylinder 21.

The intake member 14 includes a carburetor 35, an intake pipe 36 and an air cleaner 37, which are connected to the intake passage 24 in series to communicate therewith. The carburetor 35, the intake pipe 36 and the air cleaner 37 define another intake passage 38 therein communicating with the intake passage 24. The carburetor 35 includes a throttle valve 40, an actuator 41, a choke valve 42 and an actuator 43. The throttle valve 40 varies the opening of the intake passage 38. The actuator 41 can be a step motor and can actuate the throttle valve 40. The choke valve 42 varies the opening of the intake passage 38 at a position upstream of the throttle valve 40. The actuator 43 can be a step motor and can actuate the choke valve 42.

The exhaust member 16 can include an exhaust pipe 45 and a muffler 46, which can be connected to the exhaust passage 25 in series to communicate therewith. The exhaust pipe 45 and the muffler 46 define another exhaust passage 47 therein communicating with the exhaust passage 25.

A fuel tank 50 is disposed above the engine 9. The fuel tank 50 stores therein fuel 12 to be supplied to the engine 9 via the carburetor 35. An absorbent 52 and a canister 53 can be provided. The absorbent 52 can absorb evaporated fuel 51 generated from the fuel 12 in the fuel tank 50. The canister 53 encloses the absorbent 52 therein. The absorbent 52 can be activated carbon. Through the bottom of the canister 53, a communication hole 54 is disposed which communicates the canister 53 and the ambient atmosphere.

A communication passage 57 can be provided for communicating the upper end of the fuel tank 50 and the upper end of the canister 53. Another communication passage 58 can also be provided for communicating the upper end of the canister 53 and the air cleaner 37 of the intake member 14. A blow-by gas passage 59 can be provided for communicating the valve chamber 28 and the air cleaner 37 of the intake member 14. The passages 57 to 59 can each be formed of a flexible rubber tube.

A starter motor 65, an ignition device 66, a temperature sensor 67 and a rotational speed sensor 68 can be provided. The starter motor 65 starts the engine 9. The ignition device 66 causes the spark plug 31 to selectively discharge electricity. The temperature sensor 67 detects the temperature of the engine body 10 of the engine 9. The rotational speed sensor 68 can detect the rotational speed of the crankshaft 9 of the engine body 10. Specifically, the temperature sensor 67 can detect the temperature of the atmosphere in a head cover of the engine body 10. The rotational speed sensor 68 can be installed in a controller 69, and can monitor the period of time for which the voltage waveform of the electricity outputted from the generator 8 is repeated to thereby detect the speed (N) of the engine 9.

A controller 69, a battery 70, a main switch 71 and a starter switch 72 can be provided. The controller 69 can receive detection signals from the temperature sensor 67 and the rotational speed sensor 68 to electronically control the actuators 41, 43 and the ignition device 66. The battery 70 can receive a part of the electricity generated by the generator 8, via the controller 69, to store it therein and to supply the electricity to the actuators 41, 43, the ignition device 66 and the like via the controller 69. The main switch 71 can selectively enable the supply of electricity from the battery 70 to the starter motor 65, the controller 69 and the like. The starter switch 72 can selectively enable the supply of electricity from the battery 70 to the starter motor 65 via the main switch 71. The controller 69 is provided with an output unit 74 for outputting the other part of the electricity generated by the generator 8 to an external load 73.

The main switch 71 and the starter switch 72 can be formed together as a key switch. As the user turns the key by a certain angle from an “off” position, the main switch 71 will be first turned ON. As the user turns the key further by a certain angle, the starter switch 72 will be turned ON, and thus the starter motor 65 will be activated. As the user releases the key, the starter switch 72 will be turned OFF automatically, and thus the starter motor 65 will be deactivated automatically. At this time, the main switch 71 will be held ON.

When the engine 9 is driven through the control of the controller, outside air 11 will be sucked through the intake member 14 into the engine 9. Fuel 12 will be supplied by the carburetor 35 to the intake air 11 to provide a mixture 13 that will be burnt in the engine 9. At a result, the engine 9 drives the generator 8, which outputs electricity. The electricity generated by the generator can be at least partially output to the load 73 via the output unit 74 of the controller 69. The burnt gas resulting from combustion in the engine 9 can be discharged to the outside through the exhaust member 16 as exhaust 15.

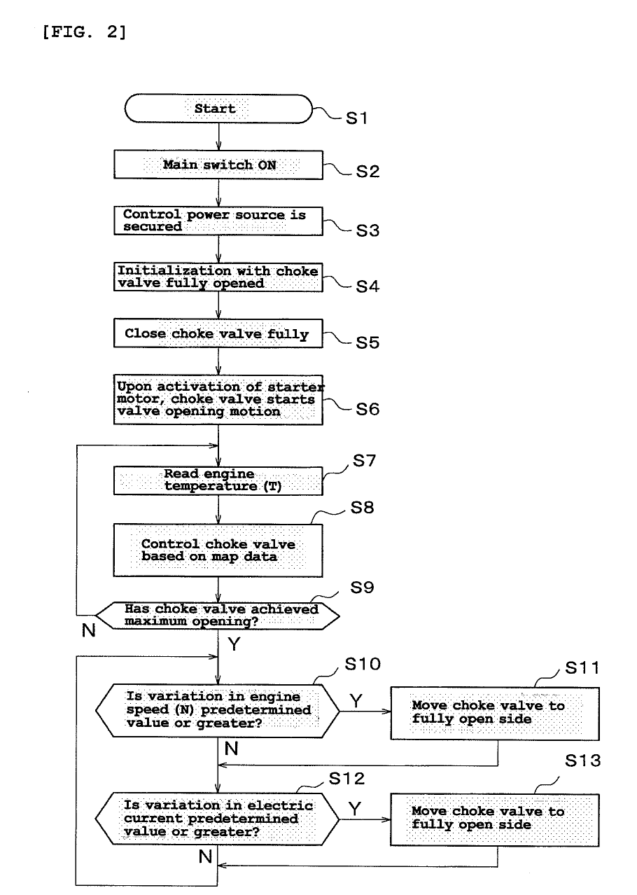

Referring to FIGS. 1 and 2, an auto choke device 80 is provided. The auto choke device 80 can control the valve opening motion of the choke valve 42 for proper start of the engine 9, when the engine 9 is started via user activation of the starter motor 65 to operate the generating apparatus 1. The auto choke device 80 can be controlled by the controller 69.

FIG. 2 is a flowchart of one control process of the opening and closing motion of the choke valve 42 for the controller 69, in which symbol S denotes each step of the program.

To start the engine 9 (S1), the main switch 71 is first turned ON by the user turning the key switch (S2). Electricity can thereby be supplied from the battery 70 to the controller 69, so that a control power source is secured (S3). Then, the actuator 43 can be activated and actuated in a forward direction in a manner causing the choke valve 42 to achieve a maximum opening (O). With the choke valve 42 fully opened, a counter of the actuator 43 is initialized (S4). Next, the actuator 43 is actuated in a reverse direction in a manner causing the choke valve 42 to achieve a fully closed state (S5).

At this time, as the user turns the key switch further, the starter switch 72 is turned ON, and thus the starter motor 65 is activated (S6). As a result, the cranking of the engine 9 is started, and the choke valve 42 starts the valve opening motion from the fully closed position (S6). Based on a detection signal from the temperature sensor 67, the temperature (T) of the engine 9 can be first read into the controller (S7). Next, proper map data can be selected in response to the detected temperature (T) of the engine 9, and the valve opening motion of the choke valve 42 is controlled based on this map data (S8). If the choke valve 42 has achieved the maximum opening (S9), the start of the engine 9 due to the control of the choke valve 42 by the controller 69 completes, and the engine 9 is brought to a normal operating state.

During the normal operation of the engine 9, when the controller 69 has determined that a variation in the engine operating state per unit time had become a predetermined value or greater, the controller 69 activates and actuates the actuator 43 in the forward direction in a manner causing the choke valve 42 to move to the fully open side to achieve the maximum opening (O).

In other words, when the variation in the engine operating state has become a predetermined value or greater, the controller 69 determines this is because the choke valve 42 has been closed by a large amount through no intention of the user, and moves the choke valve 42 to the fully open position.

Thus, when the variation has become excessively large, as described above, the choke valve 42 is moved to the fully open position to make proper the air-fuel ratio of the mixture 13 to be supplied to the engine 9, thereby bringing the engine 9 back to the normal operating state immediately.

More specifically, during the operation of the engine 9, when the controller 69 has performed a computation based on a detection signal from the rotational speed sensor 68 and determined that the variation in the speed (N) of the engine 9 had become a predetermined value (e.g., ±300 rpm/sec) or greater (S10), the controller controls the choke valve 42 to move to the fully open position (S11).

With the above configuration, variation in the operating state of the engine 9 can advantageously be detected more directly. Accordingly, when a variation has become excessively large as described above, the choke valve 42 is moved to the fully open side more promptly to bring the engine back to the normal operating state.

On the other hand, during the operation of the engine 9, when the controller 69 has performed a computation based on input of electric current from the generator 8 and determined that a variation in the electric current had become a predetermined value or greater (S12), the controller controls the choke valve 42 to move to the fully open position (S13).

As described above, when the generator 8 driven by the engine 9 is provided, the electric current from the generator 8 is usually detected by the controller 69 of the engine 9. Accordingly, using a variation in the electric current from the generator 8 to control the choke valve 42 to move to the fully open position to thereby bring the engine back to the normal operating state can be achieved with a simple configuration.

It should be understood that the foregoing description is merely based on the illustrated example, and the engine 9 can be those incorporated in other machines such as vehicles. It should also be understood that in another embodiment, a variation in the engine operating state may be detected indirectly based on variation in the load 73. Additionally, further details on a choke device for an engine, and methods operating the same can be found in U.S. application Ser. No. ______, filed Jul. 10, 2007 (Attorney Docket No. FX.00248US0A), the entire contents of which are hereby incorporated by reference and should be considered a part of this specification.

Although these inventions have been disclosed in the context of a certain preferred embodiments and examples, it will be understood by those skilled in the art that the present inventions extend beyond the specifically disclosed embodiments to other alternative embodiments and/or uses of the inventions and obvious modifications and equivalents thereof. In addition, while a number of variations of the inventions have been shown and described in detail, other modifications, which are within the scope of the inventions, will be readily apparent to those of skill in the art based upon this disclosure. It is also contemplated that various combinations or subcombinations of the specific features and aspects of the embodiments may be made and still fall within one or more of the inventions. Accordingly, it should be understood that various features and aspects of the disclosed embodiments can be combine with or substituted for one another in order to form varying modes of the disclosed inventions. Thus, it is intended that the scope of the present inventions herein disclosed should not be limited by the particular disclosed embodiments described above.

What is claimed is:

1. An engine comprising a choke valve configured to vary the opening of an intake passage of the engine, the choke valve controlled to move to a fully open position when a variation in an engine operating state per unit time during the operation of the engine becomes equal to or greater than a predetermined value.

2. The engine according to claim 1, wherein the variation is a variation in engine speed.

3. The engine according to claim 1, wherein the variation is a variation in electric current from a generator driven by the engine.

4. A method for operating an engine, comprising:
determining if a variation in an engine operating state per unit time has become equal to or greater than a predetermined value; and
controlling a choke valve of the engine to move to a fully open position if the variation in engine operating state is equal to or greater than the predetermined value.

5. The method of claim 4, wherein the variation in engine operating state is variation in engine speed.

6. The method of claim 5, wherein the predetermined value is about 300 rpm/sec.

7. The method of claim 4, wherein the variation in engine operating state is variation in electric current from a generator driven by the engine.

8. The method of claim 4, further comprising:
activating a starter motor to start the engine;
beginning an opening motion of the choke valve from the fully closed position;
detecting a temperature of the engine;
controlling the operation of the choke valve based on data from a map; and
completing an engine start process when the choke valve has achieved a maximum opening, thereby bringing the engine into a normal operating state.
